(19) United States
(12) Patent Application Publication
(10) Pub. No.: US 2020/0203820 A1
(43) Pub. Date: Jun. 25, 2020

(54) ANTENNA MODULE INCLUDING FILTER

(71) Applicant: Samsung Electronics Co., Ltd., Suwon-si (KR)

(72) Inventors: Youngju LEE, Suwon-si (KR); Kijoon KIM, Suwon-si (KR); Seungtae KO, Suwon-si (KR)

(21) Appl. No.: 16/727,199

(22) Filed: Dec. 26, 2019

(30) Foreign Application Priority Data
Dec. 24, 2018 (KR) 10-2018-0168427

(51) Int. Cl. H01Q 1/42; H01Q 1/24

(52) U.S. Cl. CPC H01Q 1/425; H01Q 1/241

(57) ABSTRACT

A communication scheme and system for converging IoT technology and a 5th Generation (5G) communication system for supporting high data transmission rates beyond a 4th Generation (4G) system are provided. The disclosure may be utilized for an intelligent service (for example, a smart home, a smart building, a smart city, a smart car, or a connected car, health care, digital education, retails, security and safety related service) on the basis of a 5G communication technology and an IoT related technology. An antenna module of a wireless communication system is provided. The antenna module includes an antenna configured to radiate an electric wave through a radiation surface based on a signal supplied from a wireless communication chip, and a filter configured to transmit some frequency bands of the electric wave radiated from the antenna, wherein the filter is disposed to be spaced apart from the radiation surface by a preset distance.

### CROSS-REFERENCE TO RELATED APPLICATION(S)

This application is based on and claims priority under 35 U.S.C. § 119(a) of a Korean patent application number 10-2018-0168427, filed on Dec. 24, 2018, in the Korean Intellectual Property Office, the disclosure of which is incorporated by reference herein in its entirety.

### BACKGROUND

### 1. Field

The disclosure relates to an antenna module including a filter that transmits only a specific frequency band in a 5th Generation (5G) mobile communication system.

### 2. Description of Related Art

In order to meet wireless data traffic demands that have increased after 4th Generation (4G) communication system commercialization, efforts to develop an improved 5G communication system or a pre-5G communication system have been made. For this reason, the 5G communication system or the pre-5G communication system is called a beyond 4G network communication system or a post Long Term Evolution (LTE) system. In order to achieve a high data transmission rate, an implementation of the 5G communication system in a mmWave band (for example, 60 GHz band) is being considered. In the 5G communication system, technologies such as beamforming, massive Multiple-Input Multiple-Output (MIMO), Full Dimensional MIMO (FD-MIMO), array antenna, analog beam-forming, and large scale antenna are being discussed as means to mitigate a propagation path loss in the mm Wave band and increase a propagation transmission distance. Further, the 5G communication system has developed technologies such as an evolved small cell, an advanced small cell, a cloud Radio Access Network (RAN), an ultra-dense network, Device-to-Device communication (D2D), a wireless backhaul, a moving network, cooperative communication, Coordinated Multi-Points (CoMP), and received interference cancellation to improve the system network. In addition, the 5G system has developed Advanced Coding Modulation (ACM) schemes such as Hybrid Frequency Shift Keying (FSK) and Quadrature Amplitude Modulation (QAM) (FQAM) and Sliding Window Superposition Coding (SWSC), and advanced access technologies such as Filter Bank Multi Carrier (FBMC), Non Orthogonal Multiple Access (NOMA), and Sparse Code Multiple Access (SCMA).

Meanwhile, the Internet has been evolved to an Internet of Things (IoT) network in which distributed components such as objects exchange and process information from a human-oriented connection network in which humans generate and consume information. An Internet of Everything (IoE) technology in which a big data processing technology through a connection with a cloud server or the like is combined with the IoT technology has emerged. In order to implement IoT, technical factors such as a sensing technique, wired/wireless communication, network infrastructure, service-interface technology, and security technology are required, and research on technologies such as a sensor network, Machine-to-Machine (M2M) communication, Machine-Type Communication (MTC), and the like for connection between objects has recently been conducted. In an IoT environment, through collection and analysis of data generated in connected objects, an intelligent Internet Technology (IT) service to create a new value for peoples' lives may be provided. The IoT may be applied to fields such as those of a smart home, a smart building, a smart city, a smart car, a connected car, a smart grid, health care, a smart home appliance, or high-tech medical services through the convergence of the Information Technology (IT) of the related art and various industries.

Accordingly, various attempts to apply the 5G communication to the IoT network are made. For example, the 5G communication technology, such as a sensor network, machine-to-machine (M2M) communication, and machine-type communication (MTC), has been implemented by a technique, such as beamforming, MIMO, and array antennas. The application of a cloud RAN as the big data processing technology may be an example of convergence of the 5G technology and the IoT technology.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an antenna module including a filter that transmits only a specific frequency band in a 5G mobile communication system.

Additional aspects will be set forth in part in the description which follows and, in part, will be apparent from the description, or may be learned by practice of the presented embodiments.

In accordance with an aspect of the disclosure, an antenna module of a wireless communication system is provided. The antenna module includes an antenna configured to radiate an electric wave through a radiation surface based on a signal supplied from a wireless communication chip, and a filter configured to transmit some frequency bands of the electric wave radiated from the antenna, wherein the filter is disposed to be spaced apart from the radiation surface by a preset distance.

In accordance with another aspect of the disclosure, an antenna module of a wireless communication system is provided. The antenna module includes an antenna configured to radiate an electric wave based on a signal supplied by a wireless communication chip, a radome disposed to be spaced apart from the radiation surface by a preset distance and configured to protect the antenna from an external impact, and a filter configured to transmit some frequency bands of the electric wave radiated from the antenna, wherein the filter may be disposed on one surface of the radome that faces the radiation surface of the antenna.

In accordance with another aspect of the disclosure, an electronic device of a wireless communication system is provided. The electronic device includes an antenna configured to radiate an electric wave based on a signal supplied by a wireless communication chip, and a filter configured to transmit some frequency bands of the electric wave radiated from the antenna, wherein the filter is disposed to be spaced apart from the radiation surface by a preset distance.

In accordance with another aspect of the disclosure, an electronic device of a wireless communication system is provided. The electronic device includes an antenna configured to radiate an electric wave through a radiation surface based on a signal supplied by a wireless communication chip, a radome disposed to be spaced apart from the radiation surface by a preset distance and configured to protect the antenna from an external impact, and a filter configured to transmit some frequency bands of the electric wave radiated from the antenna, wherein the filter may be disposed on one surface of the radome that faces the radiation surface of the antenna.

In accordance with another aspect of the disclosure, the volume occupied by a filter in an antenna module can be reduced, and accordingly, the antenna module can be lightweight.

In accordance with another aspect of the disclosure, the performance of the filter can be improved through a multilayered filter structure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages, of certain embodiments of the disclosure will be more apparent from the following description taken in conjunction with the accompanying drawings, in which:

FIG. 1 is a view illustrating a structure of an antenna module according to an embodiment of the disclosure;

FIG. 2 is a view illustrating a structure of a filter according to an embodiment of the disclosure;

FIG. 3A is a view illustrating an equivalent circuit of an internal structure of a filter according to an embodiment of the disclosure;

FIG. 3B is a view illustrating a first shape of a filter according to an embodiment of the disclosure;

FIG. 3C is a view illustrating a second shape of a filter according to an embodiment of the disclosure;

FIG. 4 is a view illustrating a characteristic graph of an antenna module including a filter according to an embodiment of the disclosure;

FIG. 5 is a view illustrating a structure of an antenna module including a filter including a plurality of layers according to an embodiment of the disclosure;

FIG. 6 is a view illustrating a characteristic graph of an antenna module including a filter including a plurality of layers according to an embodiment of the disclosure;

FIG. 7 is a view illustrating characteristic graphs of an antenna module including a filter and an antenna module that does not include a filter according to an embodiment of the disclosure; and

FIG. 8 is a view illustrating a structure of an antenna module, in which a radome is formed in a filter, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not entirely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, a “unit” refers to a software element or a hardware element, such as a Field Programmable Gate Array (FPGA) or an Application Specific Integrated Circuit (ASIC), which performs a predetermined function. However, a “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a “unit” may be either combined into a smaller number of elements, or divided into a larger number of elements. Moreover, the elements and “units” may be implemented to reproduce one or more CPUs within a device or a security multimedia card. Also, in an embodiment, a “˜unit” may include one or more processors.

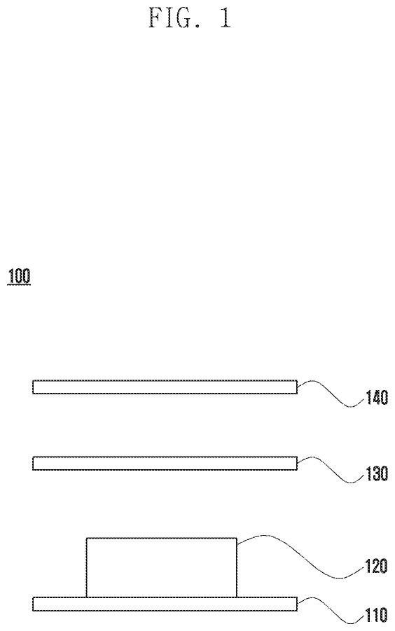

FIG. 1 is a view illustrating a structure of an antenna module according to an embodiment of the disclosure.

Referring to FIG. 1, according to an embodiment, an antenna module 100 may include an antenna 120that radiates an electric wave through a radiation surface on the basis of a signal supplied from a wireless communication chip, and a filter 130 that is disposed to be spaced apart from the radiation surface by a preset distance to transmit some frequency bands of the electric wave radiated from the antenna 120.

According to an embodiment, the antenna 120 may be disposed on an upper end surface of a printed circuit board 110 on which at least one layer is laminated, and may receive a radio frequency (RF) signal for radiating an electric wave from a wireless communication chip (not illustrated) disposed on a lower end surface of the printed circuit board 110.

According to an embodiment, the printed circuit board 110 may include a feeding line for transmitting the signal transmitted from the wireless communication chip to the antenna 120. According to various embodiments, a plurality of antennas may be disposed on the upper surface of the printed circuit board 110, and the printed circuit board 110 may distribute the signal transmitted from the wireless communication chip and transmit the distributed signals to the antennas.

According to an embodiment, the filter 130 may include a pattern in which a specific shape is periodically disposed, and the pattern may include a metallic material. According to various embodiments, the filter 130 may include a nonmetallic material (e.g., plastic), and the pattern may include a metallic material.

According to an embodiment, the electric wave radiated through the antenna 120 may be filtered by the pattern included in the filter 130. For example, among the electric wave radiated by the pattern included in the filter through the antenna 120, only a frequency of a band of 28 GHz may pass through the filter and may be radiated to the outside of the antenna module 100.

According to an embodiment, the antenna 120 may radiate a horizontally polarized wave and a vertically polarized wave, and the filter 130 may transmit only a specific frequency band of the horizontally polarized wave radiated through the antenna 120 and transmit only a specific frequency band of the vertically polarized wave radiated through the antenna 120 at the same time.

According to an embodiment, the antenna module 100 may include a radome 140 that protects the antenna 120 and the filter 130 from an external impact. According to various embodiments, a filter that transmits some frequency bands of the electric wave radiated from the antenna 120 may be disposed on one surface of the radome 140.

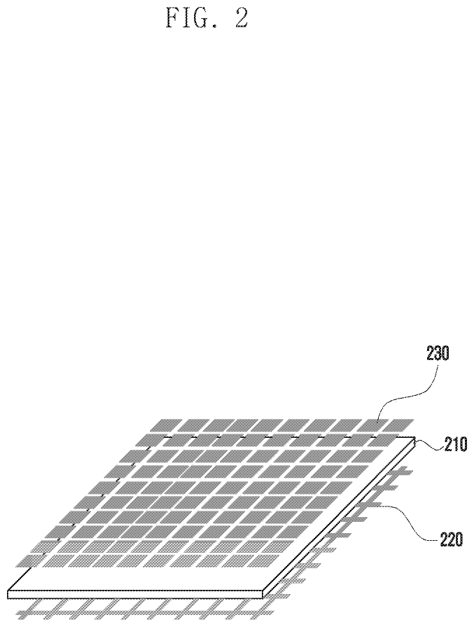

FIG. 2 is a view illustrating a structure of a filter according to an embodiment of the disclosure.

Referring to FIG. 2, according to an embodiment, a first layer 220 including a first pattern, in which a first shape is periodically disposed, may be disposed on one surface of a filter 210, and a second layer 230 including a second pattern, in which a second shape is periodically disposed, may be disposed on an opposite surface of the filter 210.

According to an embodiment, the filter 210 may include a nonmetallic material. For example, the filter 210 may include plastic. According to various embodiments, the first layer 220 disposed on the one surface of the filter 210 may include a metallic material, and the second layer 230 disposed on an opposite surface of the filter 210 may include a metallic material. According to various embodiments, the first layer 220 may be fused to the one surface of the filter 210, and the second layer 230 may be fused to the opposite surface of the filter 210.

According to an embodiment, the first layer 220 may be configured such that a grid shape is periodically disposed. For example, the first layer 220 may be a pattern in which a rectangular ring shape is periodically disposed. According to various embodiments, an inductance value of the filter 210 may be adjusted by the first layer 220 including a metallic material.

FIG. 2 illustrates only the case in which the first layer 220 is a pattern in which a rectangular ring shape is periodically disposed, but it is noted that the scope of the disclosure is not limited thereto. For example, the pattern of the first layer 220 may include various shapes, such as a triangular ring shape and a circular ring shape.

According to an embodiment, the second layer 230 may be configured such that a patch shape is periodically disposed. For example, the second layer 230 may be a pattern in which a rectangular shape is periodically disposed. According to various embodiments, a capacitance value of the filter 210 may be adjusted by the second layer 230 including a metallic material.

FIG. 2 illustrates only the case in which the second layer 230 is a pattern in which a rectangular shape is periodically disposed, but it is noted that the scope of the disclosure is not limited thereto. For example, the pattern of the second layer 230 may include various shapes, such as a triangular shape and a circular shape.

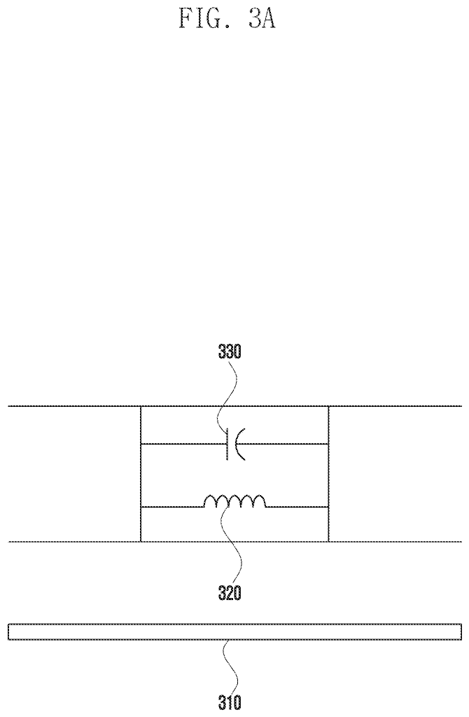

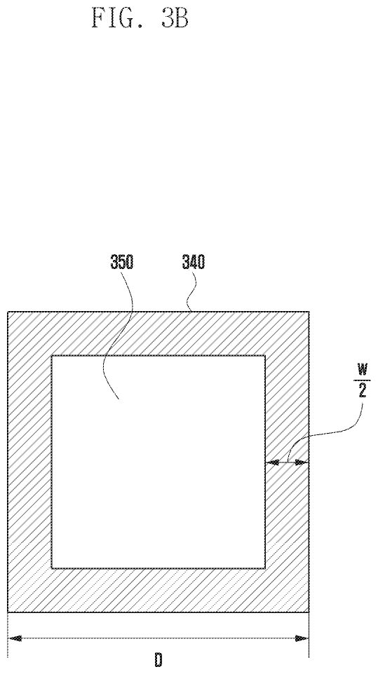

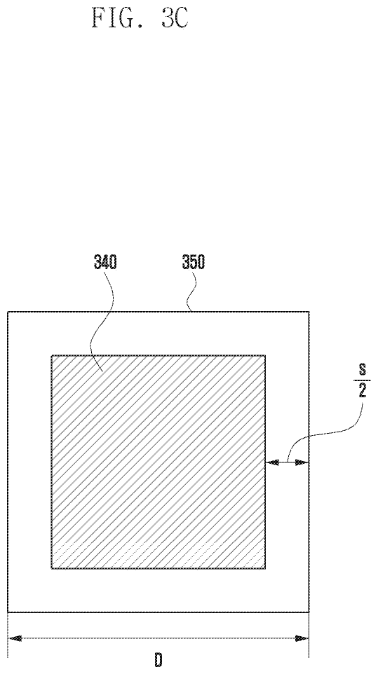

FIG. 3A is a view illustrating an equivalent circuit of an internal structure of a filter according to an embodiment of the disclosure.

Referring to FIG. 3A, according to an embodiment, the filter may include an inductor 320 and a capacitor 330. For example, an inductor having a specific inductance value may be disposed on one surface of the filter by periodically patterning a metallic material of a grid shape on one surface of the filter. Further, a capacitor having a specific capacitance value may be disposed on an opposite surface of the filter by patterning a metallic material of a patch shape on an opposite surface of the filter.

According to an embodiment, the characteristics of the filter may be determined on the basis of the inductance value of the inductor 320 and the capacitance value of the capacitor 330. For example, the pass frequency band, the quality factor (Q-factor), and the cutoff frequency of the filter may be determined on the basis of the inductance value of the inductor 320 and the capacitance value of the capacitor 330.

According to an embodiment, the filter including the inductor 320 and the capacitor 330 may be operated as a band pass filter. For example, the filter may transmit only some frequency bands (e.g., 26 GHz) of the electric wave radiated from an antenna 310.

FIG. 3A illustrates the case in which the filter includes the inductor 320 and the capacitor 330, but it is noted that the scope of the disclosure is not limited thereto. For example, the filter may include only the inductor 320 or the capacitor 330. According to various embodiments, when the filter includes only an inductor or a capacitor 330, the filter may be operated as a low pass filter or a high pass filter.

FIG. 3B is a view illustrating a first shape of a filter according to an embodiment of the disclosure.

Referring to FIG. 3B, according to an embodiment, a pattern, in which a rectangular ring shape is periodically disposed, may be disposed on one surface of the filter. For example, each of the rectangular ring shapes may have a square ring shape. According to various embodiments, a square ring shape 340 may include a metallic material, and a portion 350 of the filter, except for the square ring shapes, may include a nonmetallic material.

According to an embodiment, when the square ring shapes are patterned on one surface of the filter, the filter may have an inductance component. For example, when the square ring shapes constituting the pattern are disposed as in FIG. 3B, the inductance value of the filter may be determined as in Equation 1.

$$L = {μ}_{0} {μ}_{eff} \frac{D}{2 π} ln ( \frac{1}{sin \frac{π w}{2 D}} ) \qquad Equation 1$$

In Equation 1, the variable L describes the inductance value of the filter, the variable D describes the length of one side of the square, the variable w describes the width of the grid, the variable μ₀ describes the permeability of a vacuum state, and the variable μ_{eff} describes the specific inductive capacity.

According to an embodiment, as disclosed in Equation 1, the inductance value of the filter may be determined on the basis of the size of the grid shape patterned on one surface of the filter.

FIG. 3C is a view illustrating a second shape of a filter according to an embodiment of the disclosure.

Referring to FIG. 3C, according to an embodiment, a pattern, in which a rectangular patch shape is periodically disposed, may be disposed on one surface of the filter. For example, each of the rectangular shapes may have a square shape. According to various embodiments, the square shape 340 may include a metallic material, and a portion 350 of the filter, except for the square shapes, may include a nonmetallic material.

According to an embodiment, when the square shapes are patterned on one surface of the filter, the filter may have a capacitance component. For example, when the square shapes constituting the pattern are disposed as in FIG. 3C, the capacitance value of the filter may be determined as in Equation 2.

$$C = {ɛ}_{0} {ɛ}_{eff} \frac{2 D}{π} ln ( \frac{1}{sin \frac{π s}{2 D}} ) \qquad Equation 2$$

In Equation 2, the variable C describes the capacitance value of the filter, the variable D describes the length of a pattern unit, the variable s describes the interval between square patches, the variable ε₀ describes the permittivity, and the variable ε_{eff} describes the specific inductive capacity of a vacuum state.

According to an embodiment, as disclosed in Equation 2, the capacitance value of the filter may be determined on the basis of the size of the patch shape patterned on one surface of the filter.

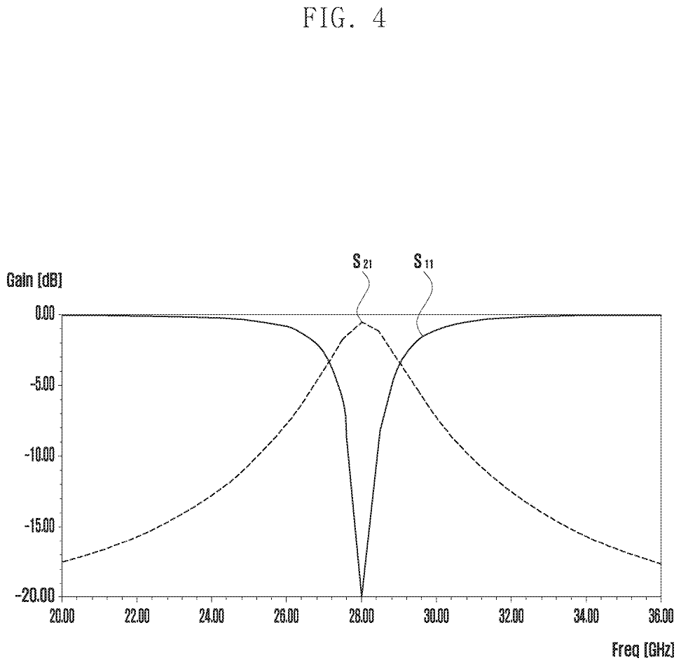

FIG. 4 is a view illustrating a characteristic graph of an antenna module including a filter according to an embodiment of the disclosure.

Referring to FIG. 4, according to an embodiment, curve S₁₁ may be determined on the basis of a ratio of a signal input to the filter and a signal which does not pass through the filter but is reflected. For example, curve S₁₁ may be determined on the basis of a value obtained by dividing the signal that does not pass through the filter but is reflected by the signal input to the filter.

According to an embodiment, curve S₂₁ may be determined on the basis of a ratio of a signal input to the filter to a signal which passes through the filter. For example, curve S₂₁ may be determined on the basis of a value obtained by dividing the signal that passes through the filter by the signal input to the filter.

According to an embodiment, the antenna module having characteristics of curve S₁₁ and curve S₂₁ of FIG. 4 may radiate an input signal of a frequency band of 28 GHz to the outside of the antenna module, and may filter an input signal of frequency bands, except for the frequency band of 28 GHz with the filter.

According to various embodiments, the antenna module having frequency characteristics illustrated in FIG. 4 may include a band pass filter that transmits only a frequency band of 28 GHz, and the band pass filter may be disposed to be spaced apart from the radiation surface of the antenna module by a preset distance and a pattern, in which a specific shape is periodically disposed, may be disposed on one surface of the band pass filter.

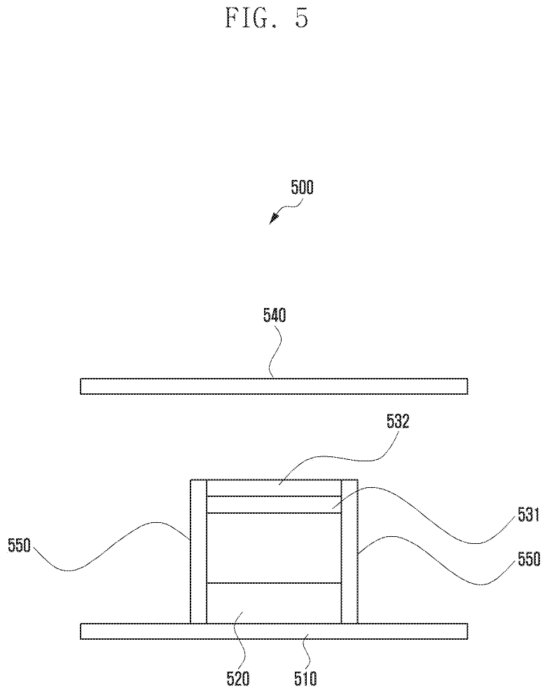

FIG. 5 is a view illustrating a structure of an antenna module including a filter including a plurality of layers according to an embodiment of the disclosure.

Referring to FIG. 5, according to an embodiment, an antenna module 500 may include an antenna 520 that radiates an electric wave through a radiation surface on the basis of a signal supplied from a wireless communication chip, a first filter 531 that is disposed to be spaced apart from the radiation surface by a preset distance to transmit only some frequency bands of the electric wave radiated from the antenna, and in which a first shape is periodically disposed, and a second filter 532 that transmits only some frequency bands of the electric wave radiated from the antenna and includes a second pattern, in which a second shape is periodically disposed.

According to an embodiment, the antenna 520 may be disposed on an upper end surface of the printed circuit board 510 on which at least one layer is laminated, and may receive a radio frequency (RF) signal for radiating an electric wave from a wireless communication chip (not illustrated) disposed on a lower end surface of the printed circuit board 510.

According to an embodiment, the first pattern, in which the first shape is periodically disposed, may be patterned on one surface of the first filter 531. According to various embodiments, the first shape may include a grid shape or a patch shape. According to an embodiment, the inductance value of the first filter 531 or the capacitance value of the first filter 531 may be adjusted according to the shape type of the first shape.

According to an embodiment, the first pattern, in which the first shape is periodically disposed, may be patterned on one surface of the first filter 531, and the third pattern, in which the third shape is periodically disposed, may be patterned on an opposite surface of the first filter 531. According to various embodiments, the first shape may be a grid shape and the third shape may be a patch shape.

According to an embodiment, the first filter 531 and the second filter 532 may be disposed to overlap each other. According to various embodiments, the first filter 531 and the second filter 532 may be disposed to be spaced apart from each other by a specific distance. For example, the first filter 531 and the second filter 532 may be disposed to be spaced apart from each other by a specific distance such that a λ/4 transformer is disposed between the first filter 531 and the second filter 532.

According to an embodiment, the second pattern, in which the second shape is periodically disposed, may be patterned on one surface of the second filter 532. According to various embodiments, the second shape may include a grid shape or a patch shape. According to an embodiment, the inductance value of the second filter 532 or the capacitance value of the second filter 532 may be adjusted according to the shape type of the second shape.

According to an embodiment, the second pattern, in which the second shape is periodically disposed, may be patterned on one surface of the second filter 532, and the fourth pattern, in which the fourth shape is periodically disposed, may be patterned on an opposite surface of the second filter 532. According to various embodiments, the second shape may be a grid shape and the fourth shape may be a patch shape.

According to an embodiment, the antenna module 500 may include a fixing part 550 that fixes the first filter 531 and the second filter 532. The fixing part 550 may be disposed on an upper end surface of a printed circuit board 510. According to various embodiments, the fixing part 550 may fix the first filter 531 and the second filter 532 such that the first filter 531 and the second filter 532 are disposed to be spaced apart from the antenna 520 by a preset distance.

According to an embodiment, the fixing part 550 may fix the first filter 531 and the second filter 532 such that the first filter 531 and the second filter 532 are disposed to be spaced apart from each other by a preset distance. According to various embodiments, the fixing part 550 may include a nonmetallic material.

According to an embodiment, the antenna module 500 may include a radome 540 that protects the antenna 520, the first filter 531, and the second filter 532 from an external impact. According to various embodiments, a third filter that transmits some frequency bands of the electric wave radiated from the antenna 520 may be disposed on one surface of the radome 540.

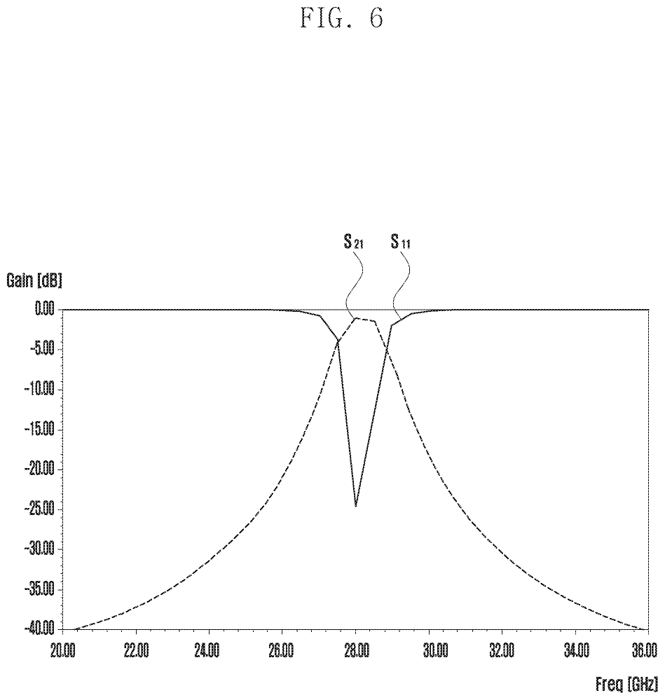

FIG. 6 is a view illustrating a characteristic graph of an antenna module including a filter including a plurality of layers according to an embodiment of the disclosure.

Referring to FIG. 6, according to an embodiment, the antenna module having characteristics of curve S₁₁ and curve S₂₁ of FIG. 6 may radiate an input signal of a frequency band of 28 GHz to the outside of the antenna module, and may filter an input signal of frequency bands, except for the frequency band of 28 GHz with the filter.

According to various embodiments, the antenna module having frequency characteristics illustrated in FIG. 6 may include a band pass filter that transmits only a frequency band of 28 GHz, and the band pass filter may be disposed to be spaced apart from the radiation surface of the antenna module by a preset distance and may include a plurality of layers, and a pattern, in which a specific shape is periodically disposed, may be disposed on one surface of each of the layers.

According to an embodiment, the quality factor (Q-factor) of the filter including a plurality of layers, in which patterns are disposed, may be higher than the quality factor of the filter including one layer, in which a pattern is disposed. According to various embodiments, the filtering performance of the filter including a plurality of layers, in which patterns are disposed, may be higher than the filtering performance of the filter including one layer, in which a pattern is formed.

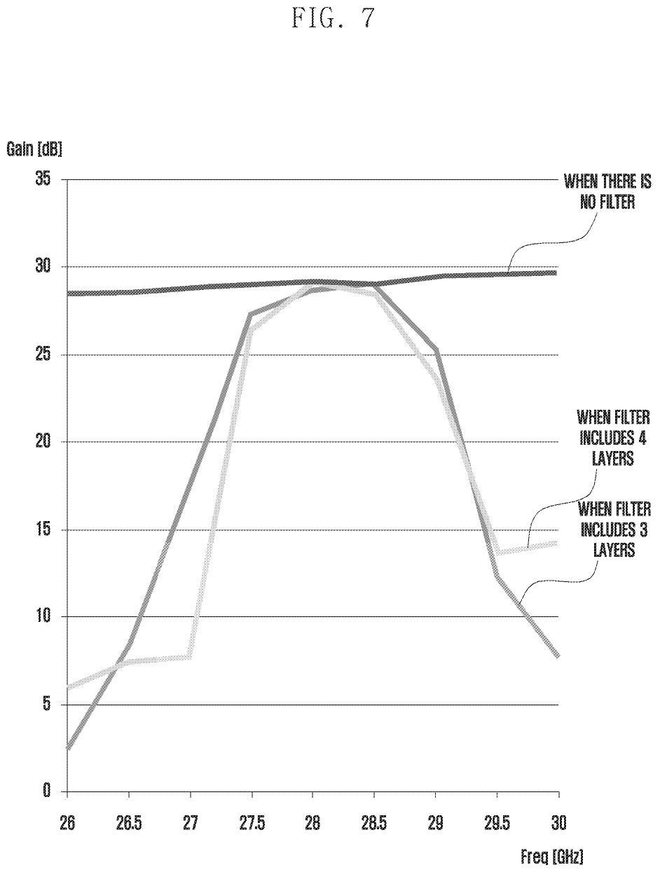

FIG. 7 is a view illustrating characteristic graphs of an antenna module including a filter and an antenna module that does not include a filter according to an embodiment of the disclosure.

Referring to FIG. 7, according to the graph illustrated in FIG. 7, it can be identified that the antenna module that does not include the filter according to the disclosure radiates an electric wave at all frequency bands of 26 to 30 GHz.

It can also be identified that when the antenna module includes a filter, the antenna module radiates an electric wave of a frequency band of 28 GHz. That is, it can be identified through the graph of FIG. 7 that the electric wave of a frequency band of 26 to 27 GHz and the electric wave of a frequency band of 29 to 30 GHz are filtered by the filter included in the antenna module.

According to an embodiment, the filter included in the antenna module may include three layers or four layers. For example, the filter may include three layers, and a pattern, in which a specific shape is periodically disposed, may be disposed on one surface of each of the layers. According to various embodiments, the shape of the patterns formed on surfaces of the layers may be different.

According to an embodiment, as the number of the layers included in the filter increases, the performance of the filter may be enhanced. For example, as the number of the layers included in the filter increases, the quality factor of the filter may be increased.

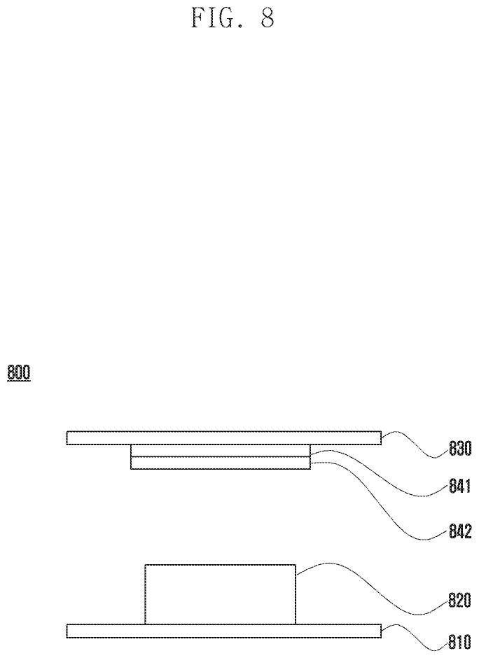

FIG. 8 is a view illustrating a structure of an antenna module, in which a radome is formed in a filter, according to an embodiment of the disclosure.

Referring to FIG. 8, according to an embodiment, an antenna module 800 may include an antenna 820 that radiates an electric wave through a radiation surface on the basis of a signal supplied from a wireless communication chip, and a radome 830 that is disposed to be spaced apart from the radiation surface by a preset distance to protect the antenna 820 from an external impact.

According to an embodiment, filters 841 and 842 that transmit some frequency bands of the electric wave radiated from the antenna 820 may be disposed on one surface of the radome 830 that faces the radiation surface of the antenna 820.

According to an embodiment, the antenna 820 may be disposed on an upper end surface of a printed circuit board 810 on which at least one layer is laminated, and may receive a radio frequency (RF) signal for radiating an electric wave from a wireless communication chip (not illustrated) disposed on a lower end surface of the printed circuit board 810.

According to an embodiment, the filter may include a pattern, in which a specific shape is periodically disposed, and the pattern may include a metallic material and may be fused to one surface of the radome 830.

According to an embodiment, the filter may include the first layer 841 including a first pattern, in which a first shape is periodically disposed, and the second layer 842 including a second pattern, in which a second shape is periodically disposed. According to various embodiments, the first layer 841 and the second layer 842 may include a metallic material, and the first shape may be a grid shape and the second shape may be a patch shape.

FIG. 8 illustrates only the case in which the filter is disposed on one surface of the radome, but a structure of an antenna module, in which a filter is formed by periodically disposing a pattern on one surface of the radome 830 to maximize the performance of the filter and the filter illustrated in FIG. 5 is disposed between the antenna 820 and the radome 830, also may be considered. According to various embodiments, a printed circuit board (PCB) filter may be disposed on a lower end surface of the printed circuit board 810.

The disclosure provides an antenna module of a wireless communication system including an antenna configured to radiate an electric wave through a radiation surface on the basis of a signal supplied from a wireless communication chip, and a filter disposed to be spaced apart from the radiation surface by a preset distance and configured to transmit some frequency bands of the electric wave radiated from the antenna.

According to an embodiment, the filter may include a pattern in which a specific shape is periodically disposed, and the pattern includes a metallic material.

According to an embodiment, the pattern may be disposed such that a grid shape is periodically disposed, and an inductance value related to characteristics of the filter may be adjusted on the basis of the size of the grid shape.

According to an embodiment, the pattern may be disposed such that a patch shape is periodically disposed, and a capacitance value related to characteristics of the filter may be adjusted on the basis of the size of the patch shape.

According to an embodiment, the filter may include a first layer including a first pattern in which a first shape is periodically disposed, and a second layer including a second pattern in which a second shape is periodically disposed.

According to an embodiment, the first layer and the second layer may include a nonmetallic material, and the first shape may be a grid shape and the second shape may be a patch shape.

According to an embodiment, the antenna may radiate a horizontally polarized wave and a vertically polarized wave through the radiation surface, and the filter may transmit some frequency bands of the horizontally polarized wave and the vertically polarized wave.

The disclosure provides an antenna module of a wireless communication system including an antenna configured to radiate an electric wave on the basis of a signal supplied by a wireless communication chip, and a radome disposed to be spaced apart from the radiation surface by a preset distance and configured to protect the antenna from an external impact, and a filter configured to transmit some frequency bands of the electric wave radiated from the antenna may be disposed on one surface of the radome that faces the radiation surface of the antenna.

According to an embodiment, the filter may include a pattern in which a specific shape is periodically disposed, and the pattern includes a metallic material.

According to an embodiment, the filter may include a first layer including a first pattern in which a first shape is periodically disposed, and a second layer including a second pattern in which a second shape is periodically disposed, and the first layer and the second layer may include a nonmetallic material, and the first shape may be a grid shape and the second shape may be a patch shape.

The disclosure provides an electronic device of a wireless communication system including an antenna configured to radiate an electric wave on the basis of a signal supplied by a wireless communication chip, and a filter disposed to be spaced apart from the radiation surface by a preset distance and configured to transmit some frequency bands of the electric wave radiated from the antenna.

According to an embodiment, the filter may include a pattern in which a specific shape is periodically disposed, and the pattern may include a metallic material.

According to an embodiment, the pattern may be disposed such that a grid shape is periodically disposed, and an inductance value related to characteristics of the filter may be adjusted on the basis of the size of the grid shape.

According to an embodiment, the pattern may be disposed such that a patch shape is periodically disposed, and a capacitance value related to characteristics of the filter may be adjusted on the basis of the size of the patch shape.

According to an embodiment, the filter may include a first layer including a first pattern in which a first shape is periodically disposed, and a second layer including a second pattern in which a second shape is periodically disposed.

According to an embodiment, the first layer and the second layer may include a nonmetallic material, and the first shape may be a grid shape and the second shape may be a patch shape.

According to an embodiment, the antenna may radiate a horizontally polarized wave and a vertically polarized wave through the radiation surface, and the filter may transmit some frequency bands of the horizontally polarized wave and the vertically polarized wave.

The disclosure provides an electronic device of a wireless communication system including an antenna configured to radiate an electric wave through a radiation surface on the basis of a signal supplied by a wireless communication chip, and a radome disposed to be spaced apart from the radiation surface by a preset distance and configured to protect the antenna from an external impact, and a filter configured to transmit some frequency bands of the electric wave radiated from the antenna may be disposed on one surface of the radome that faces the radiation surface of the antenna.

According to an embodiment, the filter may include a pattern in which a specific shape is periodically disposed, and the pattern includes a metallic material.

According to an embodiment, the filter may include a first layer including a first pattern in which a first shape is periodically disposed, and a second layer including a second pattern in which a second shape is periodically disposed, and the first layer and the second layer may include a nonmetallic material, and the first shape may be a grid shape and the second shape may be a patch shape.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. An antenna module of a wireless communication system, the antenna module comprising:
an antenna configured to radiate an electric wave through a radiation surface based on a signal supplied from a wireless communication chip; and
a filter configured to transmit some frequency bands of the electric wave radiated from the antenna, the filter being disposed to be spaced apart from the radiation surface by preset distance.

2. The antenna module of claim 1,
wherein the filter comprises a pattern in which a specific shape is periodically disposed, and
wherein the pattern comprises a metallic material.

3. The antenna module of claim 2,
wherein the pattern is disposed such that a grid shape is periodically disposed, and
wherein an inductance value related to characteristics of the filter is adjusted on the basis of the size of the grid shape.

4. The antenna module of claim 2,
wherein the pattern is disposed such that a patch shape is periodically disposed, and
wherein a capacitance value related to characteristics of the filter is adjusted on the basis of the size of the patch shape.

5. The antenna module of claim 1, wherein the filter comprises:
a first layer comprising a first pattern in which a first shape is periodically disposed; and
a second layer comprising a second pattern in which a second shape is periodically disposed.

6. The antenna module of claim 5,
wherein the first layer and the second layer comprise a nonmetallic material, and
wherein the first shape is a grid shape and the second shape is a patch shape.

7. The antenna module of claim 1,
wherein the antenna radiates a horizontally polarized wave and a vertically polarized wave through the radiation surface, and
wherein the filter transmits some frequency bands of the horizontally polarized wave and the vertically polarized wave.

8. An antenna module of a wireless communication system comprising:
an antenna configured to radiate an electric wave based on a signal supplied by a wireless communication chip;
a radome disposed to be spaced apart from the radiation surface by a preset distance and configured to protect the antenna from an external impact; and
a filter configured to transmit some frequency bands of the electric wave radiated from the antenna, the filter being disposed on one surface of the radome that faces the radiation surface of the antenna.

9. The antenna module of claim 8,
wherein the filter comprises a pattern in which a specific shape is periodically disposed, and
wherein the pattern comprises a metallic material.

10. The antenna module of claim 8, wherein the filter comprises:
a first layer comprising a first pattern in which a first shape is periodically disposed; and
a second layer comprising a second pattern in which a second shape is periodically disposed,
wherein the first layer and the second layer comprise a nonmetallic material, and
wherein the first shape is a grid shape and the second shape is a patch shape.

11. An electronic device of a wireless communication system comprising:
an antenna configured to radiate an electric wave through a radiation surface based on a signal supplied by a wireless communication chip; and
a filter configured to transmit some frequency bands of the electric wave radiated from the antenna, the filter is being disposed to be spaced apart from the radiation surface by a preset distance.

12. The electronic device of claim 11,
wherein the filter comprises a pattern in which a specific shape is periodically disposed, and
wherein the pattern comprises a metallic material.

13. The electronic device of claim 12,
wherein the pattern is disposed such that a grid shape is periodically disposed, and
wherein an inductance value related to characteristics of the filter is adjusted on the basis of the size of the grid shape.

14. The electronic device of claim 12,
wherein the pattern is disposed such that a patch shape is periodically disposed, and
wherein a capacitance value related to characteristics of the filter is adjusted on the basis of the size of the patch shape.

15. The electronic device of claim 11, wherein the filter comprises:
a first layer comprising a first pattern in which a first shape is periodically disposed; and
a second layer comprising a second pattern in which a second shape is periodically disposed.

16. The electronic device of claim 15,
wherein the first layer and the second layer comprise a nonmetallic material, and
wherein the first shape is a grid shape and the second shape is a patch shape.

17. The electronic device of claim 11,
wherein the antenna radiates a horizontally polarized wave and a vertically polarized wave through the radiation surface, and
wherein the filter transmits some frequency bands of the horizontally polarized wave and the vertically polarized wave.

18. An electronic device of a wireless communication system comprising:
an antenna configured to radiate an electric wave through a radiation surface based on a signal supplied by a wireless communication chip;
a radome disposed to be spaced apart from the radiation surface by a preset distance and configured to protect the antenna from an external impact; and
a filter configured to transmit some frequency bands of the electric wave radiated from the antenna, the filter being disposed on one surface of the radome that faces the radiation surface of the antenna.

19. The electronic device of claim 18,
wherein the filter comprises a pattern in which a specific shape is periodically disposed, and
wherein the pattern comprises a metallic material.

20. The electronic device of claim 18, wherein the filter comprises:
a first layer comprising a first pattern in which a first shape is periodically disposed; and
a second layer comprising a second pattern in which a second shape is periodically disposed,
wherein the first layer and the second layer comprise a nonmetallic material, and
wherein the first shape is a grid shape and the second shape is a patch shape.

21. The antenna module of claim 3, wherein the grid shape is substantially square.

22. The antenna module of claim 21, wherein the inductance value of the filter may be determined as,
$$L = {μ}_{0} {μ}_{eff} \frac{D}{2 π} ln ( \frac{1}{sin \frac{π w}{2 D}} )$$
wherein L is the inductance value of the filter, D is a length of one side of the square, w is a width of a grid, μ₀ is a permeability of a vacuum state, and ε_{eff} is a specific inductive capacity.

23. The antenna module of claim 4, wherein the patch shape is substantially square.

24. The antenna module of claim 23, wherein the capacitance value of the filter may be determined as,
$$C = {ɛ}_{0} {ɛ}_{eff} \frac{2 D}{π} ln ( \frac{1}{sin \frac{π s}{2 D}} )$$
wherein C is the capacitance value of the filter, D is a length of a pattern unit, s is an interval between square patches, ε₀ is a permittivity, and ε_{eff} is a specific inductive capacity of a vacuum state.
